(19) United States
(12) Patent Application Publication
(10) Pub. No.: US 2025/0389573 A1
(43) Pub. Date: Dec. 25, 2025

(54) LIQUID LEVEL SENSING DEVICE

(71) Applicant: Nick Angelo, McKinney, TX (US)

(72) Inventor: Nick Angelo, McKinney, TX (US)

(21) Appl. No.: 18/753,915

(22) Filed: Jun. 25, 2024

(51) Int. Cl. G01F 23/292; G01F 23/80

(52) U.S. Cl. CPC G01F 23/292; G01F 23/802

(57) ABSTRACT

A liquid level sensing device can include a holding tank mounted on a motor vehicle, wherein the holding tank is constructed to hold solid waste, liquid waste, water, or any combination thereof; an enclosure having a side that includes at least one millimeter-wave lens, wherein the side that includes the at least one millimeter-wave lens is mounted on the holding tank; at least one radar sensor mounted in the enclosure, wherein the at least one millimeter-wave lens is positioned between the holding tank and the at least one radar sensor; memory; one or more processors operably coupled to the memory and the at least one radar sensor, wherein the one or more processors are configured at least to: receive first radar sensor data from the at least one radar sensor; and determine a fill level of the holding tank based at least on the first radar sensor data.

### TECHNICAL FIELD

The embodiments generally relate to the field of fill level sensing devices.

### BACKGROUND

A typical liquid level sensing device often requires an opening be formed in the container on which the device is mounted so that the device can accurately determine the level in the container. However, such an opening makes the sensing device susceptible to moisture contamination by any contents inside the container.

There is a need for a liquid level sensing device that does not require an opening in the container on which the liquid level sensing device is mounted.

### SUMMARY

This summary is provided to introduce a variety of concepts in a simplified form that is further disclosed in the detailed description of the embodiments. This summary is not intended to identify key or essential inventive concepts of the claimed subject matter, nor is it intended for determining the scope of the claimed subject matter.

In general, the disclosed liquid level sensing device can include a holding tank constructed to be mounted on a motor vehicle, wherein the holding tank is constructed to hold solids, liquids, or a combination thereof. For example, the holding tank can be constructed to hold solid waste, liquid waste, water, fuel (e.g., gasoline, diesel), or any combination thereof. The liquid level sensing device can further include an enclosure having a first side that includes at least one millimeter-wave lens, wherein the first side that includes the at least one millimeter-wave lens is mounted on the holding tank; at least one radar sensor mounted in the enclosure, wherein the at least one millimeter-wave lens is positioned between the holding tank and the at least one radar sensor; memory; one or more processors operably coupled to the memory and the at least one radar sensor, wherein the one or more processors are configured at least to: receive first radar sensor data from the at least one radar sensor; and determine a fill level of the holding tank based at least on the first radar sensor data.

Other illustrative variations within the scope of the invention will become apparent from the detailed description provided hereinafter. The detailed description and enumerated variations, while disclosing optional variations, are intended for purposes of illustration only and are not intended to limit the scope of the invention.

### BRIEF DESCRIPTION OF THE DRAWINGS

A more complete understanding of the embodiments, and the attendant advantages and features thereof, will be more readily understood by references to the following detailed description when considered in conjunction with the accompanying drawings wherein:

FIG. 1 illustrates a liquid level sensing device, according to some embodiments disclosed herein;

FIG. 2 illustrates a liquid level sensing device mounted on a holding tank, according to some embodiments disclosed herein;

FIG. 3 illustrates a liquid level sensing device mounted on a holding tank with an opening formed in the holding tank, according to some embodiments disclosed herein;

FIG. 4 illustrates a liquid level sensing device mounted on a holding tank, according to some embodiments disclosed herein;

FIGS. 5A and 5B illustrate a liquid level sensing device that is removeable from an enclosure mount, according to some embodiments disclosed herein;

FIG. 6 illustrates a liquid level sensing device mounted on a holding tank with an enclosure mount omitted, according to some embodiments disclosed herein;

FIG. 7 illustrates a holding tank mounted to a motor vehicle, according to some embodiments disclosed herein;

FIG. 8 illustrates a dashboard of a motor vehicle, according to some embodiments disclosed herein; and

FIG. 9 illustrates an example block diagram of hardware of a computing device operably coupled to one or more machine learning model databases, according to some embodiments disclosed herein.

The drawings are not necessarily to scale, and certain features and certain views of the drawings may be shown exaggerated in scale or in schematic in the interest of clarity and conciseness.

### DETAILED DESCRIPTION

The specific details of the single embodiment or variety of embodiments described herein are to the described product or methods of use. Any specific details of the embodiments are used for demonstration purposes only and no unnecessary limitations or inferences are to be understood from there.

It is noted that the embodiments reside primarily in combinations of components and procedures related to the products. Accordingly, the product and components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments described herein relate to a liquid level sensing device that can include an enclosure having a first side that includes at least one millimeter-wave lens, wherein the first side that includes the at least one millimeter-wave lens is mounted on a container such as, for example, a holding tank that is constructed to hold at least solid waste, liquid waste, water, or any combination thereof.

In some embodiments, the at least one millimeter-wave lens can be suitable for focusing electromagnetic radiation (e.g., from at least one radar sensor) having wavelengths in the range from approximately 1 mm to approximately 10 mm (i.e., electromagnetic radiation in the frequency range from approximately 300 GHz to approximately 30 GHz). In some embodiments, the at least one millimeter-wave lens can include a millimeter-wave Fresnel-zone plate lens.

At least one radar sensor can be mounted in the enclosure, wherein the at least one millimeter-wave lens is positioned between the holding tank and the at least one radar sensor. The at least one millimeter-wave lens can be constructed and arranged to focus radar beams from the at least one radar sensor. In some embodiments, the at least one radar sensor can include any sensor that uses radio waves to generate sensor data that indicates one or more distances to surface(s) of a liquid, surface(s) of a solid, or a combination thereof. In some embodiments, the at least one radar sensor can include a continuous wave frequency modulation (CWFM) radar sensor.

One or more processors, which can be operably coupled to the at least one radar sensor, are configured at least to determine a fill level of the holding tank based at least on radar sensor data received from the at least one radar sensor.

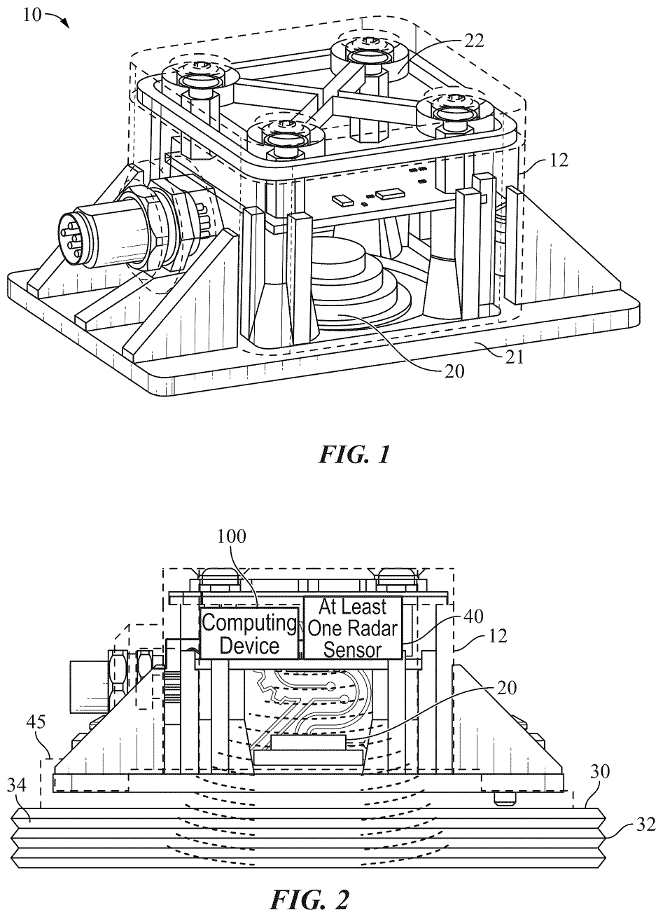

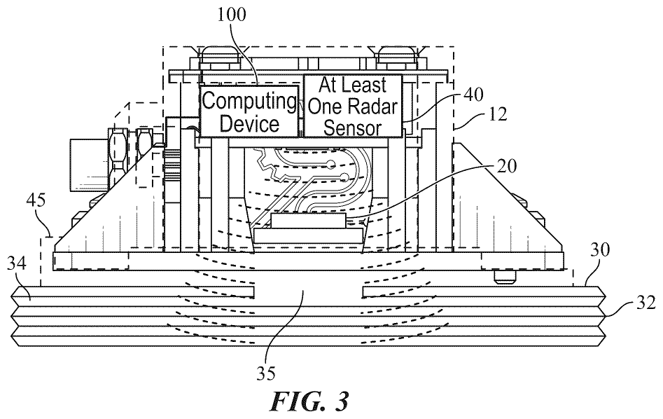

Referring to FIG. 1, a liquid level sensing device 10 can include an enclosure 12 having a first side 21 opposite a second side 22. In some embodiments, the first side 21 can include at least one millimeter-wave lens 20. In some embodiments, the at least one millimeter-wave lens 20 can be adhered onto the first side 21. In some embodiments, the at least one millimeter-wave lens 20 can be positioned at least partially inside the enclosure 12. Referring to FIG. 2, in some embodiments, the first side 21 that includes the at least one millimeter-wave lens 20 can be mounted on any suitable container such as, for example, a holding tank 30. In some embodiments, the at least one millimeter-wave lens 20 can be made primarily of a dielectric material.

In some embodiments, at least one radar sensor 40 can be mounted and positioned in the enclosure 12, wherein the at least one millimeter-wave lens 20 is positioned between the holding tank 30 and the at least one radar sensor 40. In some embodiments, at least one computing device 100 in the enclosure 12 can be operably coupled to the at least one radar sensor 40. In some embodiments, the at least one computing device 100 can be configured at least to receive radar sensor data from the at least one radar sensor 40. In some embodiments, the at least one computing device 100 can be configured at least to determine a fill level 32 of the holding tank 30 based at least on any radar sensor data received from the at least one radar sensor 40.

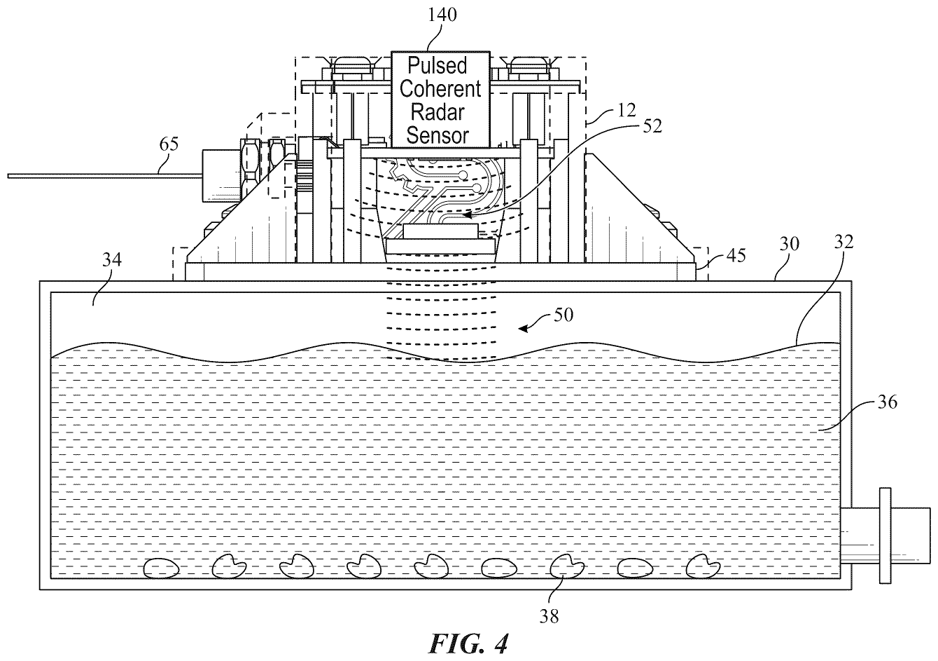

Referring to FIG. 3, in some embodiments, the holding tank 30 can include an opening 35 that faces toward the at least one radar sensor 40. In some embodiments, the opening 35 can be aligned with the at least one radar sensor 40.

Referring back to FIG. 2, in some embodiments, the holding tank 30 does not include an opening (e.g., 35 in FIG. 3) that faces toward the at least one radar sensor 40. In some embodiments, the holding tank 30 does not include an opening (e.g., 35 in FIG. 3) that is aligned with the at least one radar sensor 40. In some embodiments, the at least one radar sensor 40 is not fluidly connected to the inside 34 of the holding tank 30. In some embodiments, the at least one radar sensor 40 is fluidly sealed from the holding tank 30 by at least the enclosure 12.

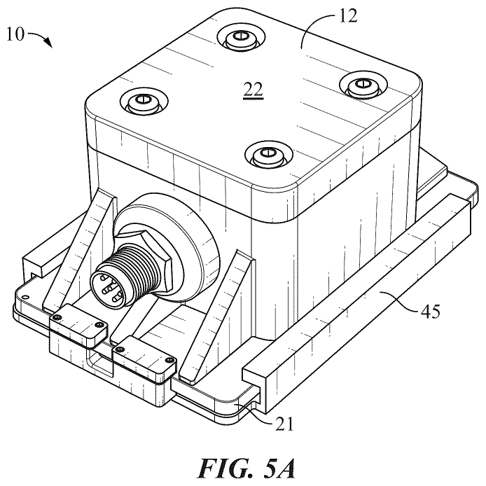

Referring to FIG. 4, the holding tank 30 can be constructed to hold at least any suitable solids such as solid waste 38. In some embodiments, the holding tank 30 can be constructed to hold at least any suitable liquids 36 such as liquid waste, water, or any combination thereof.

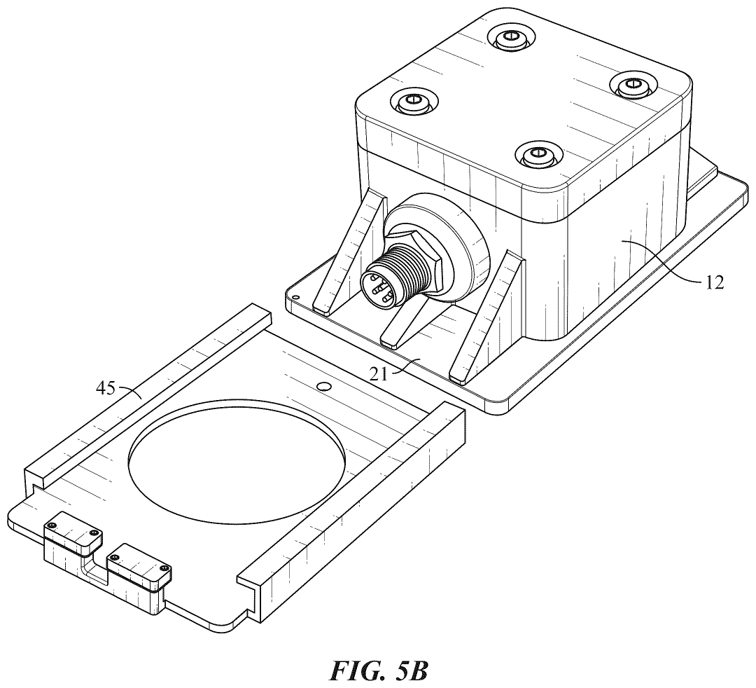

In some embodiments, an enclosure mount 45 can be adhered to the holding tank 30, wherein the enclosure mount 45 is constructed and arranged to mount the enclosure 12 to the holding tank 30. Referring to FIGS. 5A and 5B, the enclosure mount 45 can slidably release the enclosure 12. In some embodiments, the enclosure mount 45 can slidably receive the enclosure 12.

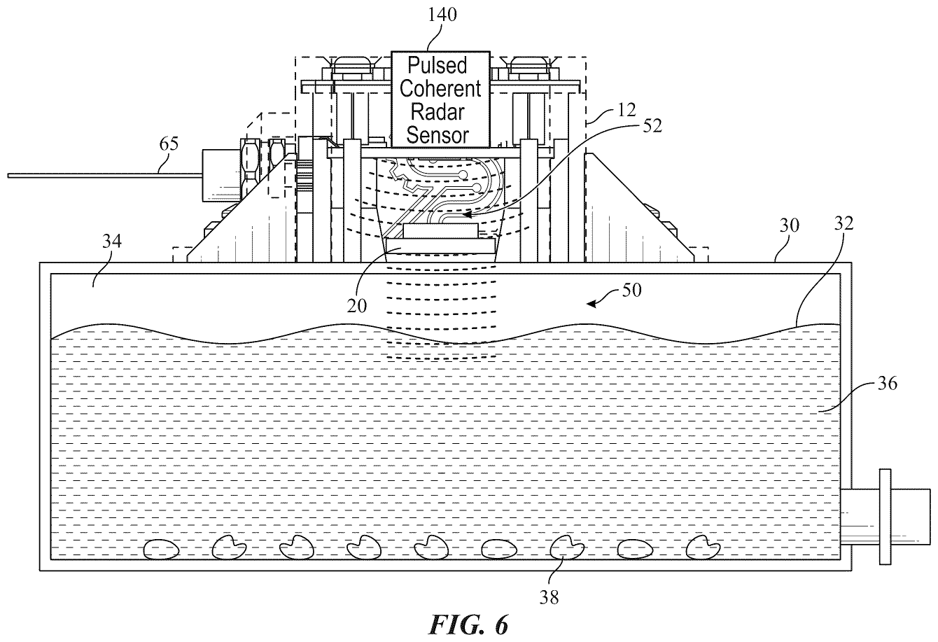

Referring to FIG. 6, in some embodiments, the enclosure mount 45 can be omitted. In such embodiments, the enclosure 12 can be mounted to the holding tank 30 by being adhered to the holding tank 30. In some embodiments, the first side 21 of the enclosure 12 that includes the at least one millimeter-wave lens 20 can be adhered to the holding tank 30.

Referring back to FIG. 4, the at least one radar sensor 40 can include a pulsed radar sensor such as a pulsed coherent radar sensor 140. In some embodiments, the pulsed coherent radar sensor 140 can be configured at least to generate at least one radar beam pulse 50. The at least one millimeter-wave lens 20 can constructed and arranged to focus a portion 52 of the at least one radar beam pulse 50 toward the holding tank 30. In some embodiments, the pulsed coherent radar sensor 140 can be configured at least to generate radar beam pulses (e.g., 50) at a predetermined frequency.

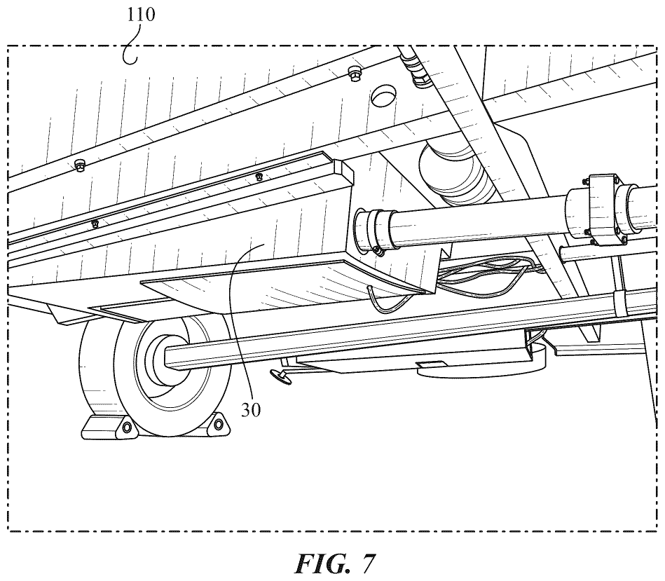

Referring to FIG. 7, the holding tank 30 can be constructed to be mounted on a motor vehicle 110. In some embodiments, the liquid level sensing device (e.g., 10 in FIG. 1) can be mounted on the holding tank 30 while the holding tank 30 is mounted on the motor vehicle 110.

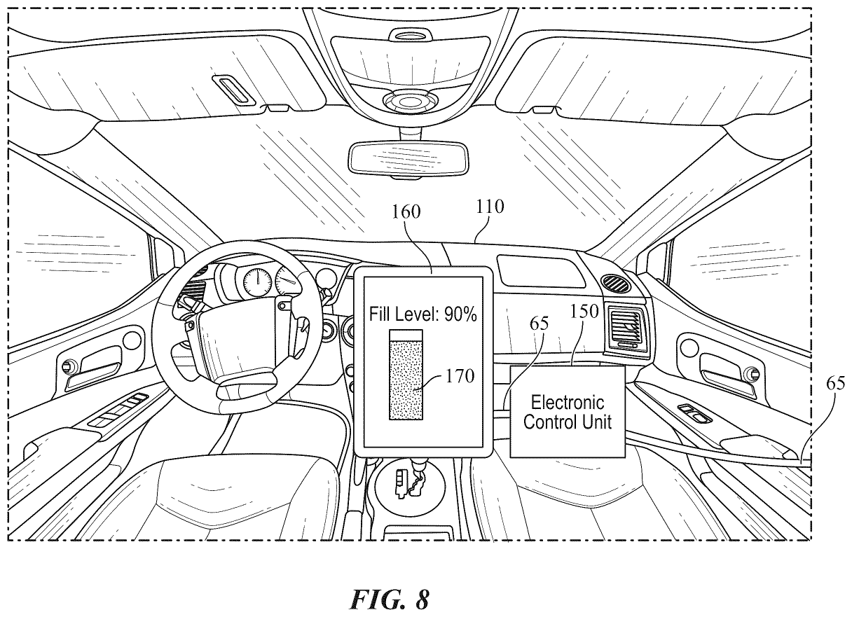

Referring to FIG. 8, at least one computing device 100 such as an electronic control unit 150 can be mounted in the motor vehicle 110, wherein the electronic control unit 150 is operably coupled to a vehicle on-board display 160 and any components of the liquid level sensing device (e.g., 10 in FIG. 1). In some embodiments, the vehicle on-board display 160, the electronic control unit 150, and the at least one radar sensor (e.g., 40 in FIG. 4) can be operably coupled via communication connections 65. Communication connections can include any suitable connections such as electrical connections, optical connections, or a combination thereof.

In some embodiments, the vehicle on-board display 160 can be configured at least to display a fill level indicator 170 indicating the fill level (e.g., 32 in FIG. 4) of the holding tank (e.g., 30 in FIG. 4) determined based at least on any radar sensor data.

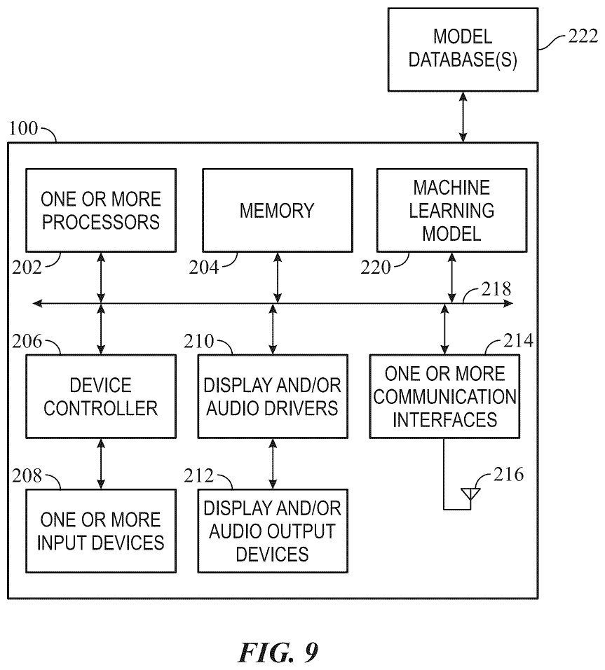

Referring to FIG. 9, an example hardware of a computing device 100 is illustrated. In some embodiments, the computing device 100 can include one or more processors 202, memory 204, a device controller 206, one or more input devices 208, display and/or audio drivers 210, display and/or audio output devices 212, one or more communication interfaces 214, one or more antennas 216, a bus 218, or any combination thereof.

In some embodiments, the one or more processors 202 can include any suitable hardware processor, such as a central processing unit (CPU), a graphics processing unit (GPU), a tensor processing unit (TPU), an accelerated processing unit (APU), any other type of processing unit, or any combination thereof. In some embodiments, the one or more processors 202 can include a microprocessor, a micro-controller, a digital signal processor, dedicated logic, an application-specific integrated circuit (ASIC), a field programmable gate array (FPGA), an accelerator (e.g., an artificial intelligence (AI) accelerator or a cryptographic accelerator), any other suitable circuitry for controlling the functioning of a general purpose computer or a special purpose computer, or any combination thereof.

In some embodiments, one or more processors 202 can be controlled by a computer program stored in memory 204. For example, the computer program can cause the one or more processors 202 to be configured to receive first radar sensor data from the at least one radar sensor (e.g., 40 in FIG. 4). In some embodiments, the one or more processors 202 can be configured at least to determine a fill level (e.g., 32 in FIG. 4) of the holding tank (e.g., 30 in FIG. 4) based at least on the first radar sensor data. In some embodiments, the one or more processors 202 can be configured at least to adjust a pulse frequency, a pulse duration, a pulse repetition interval, or any combination thereof, of radar beam pulses (e.g., 50 in FIG. 4) to be generated by the at least one radar sensor (e.g., 40 in FIG. 4). In some embodiments, the one or more processors 202 can be configured at least to perform digital signal processing on at least the first radar sensor data to remove noise, interference, or a combination thereof from at least the first radar sensor data.

In some embodiments, the one or more processors 202 can be configured at least to generate at least one feature vector based at least on historical radar sensor data including the first radar sensor data; and provide the at least one feature vector to a machine learning model 220 that is configured to determine the fill level of the holding tank. The machine learning model 220 can be trained on historical radar sensor data and any suitable user inputs. Any suitable data accessed by the machine learning model 220 can be stored in one or more machine learning model databases 222. Such suitable data can include training data that includes historical sensor data and any suitable user inputs. In some embodiments, in response to determining that the fill level of the holding tank meets a fill level threshold, the machine learning model 220 can determine that the holding tank has deformed due to the weight of contents in the holding tank, and modify the determined fill level of the holding tank based at least on the determination that the fill level of the holding tank meets the fill level threshold. In some embodiments, in response to determining that the fill level of the holding tank meets a second fill level threshold, the machine learning model 220 can determine that air bubbles in the liquid contents in the holding tank have been dislodged, and modify the determined fill level of the holding tank based at least on the determination that the fill level of the holding tank meets the fill level threshold.

The machine learning model 220 can be trained by sampling radar sensor data with windows that overlap strides, and computing either a spectrogram or similar feature extraction pre-processing algorithm. The feature extraction should be designed to reduce the input space into a neural network of the machine learning model 220. The reduction of the input space makes it possible to implement this architecture in smaller liquid level sensing devices. The feature extraction algorithm feeds the reduced input space of the neural network which then selects an output. An optional smoothing algorithm can be added to further reduce classification noise and present a more consistent output. The resultant output would be a smooth or step based linear output that will not have any of the noise induced by tank shape deformations or other noise factors.

In some embodiments, the one or more processors 202 can be operably coupled to any computing device such as an electronic control unit (e.g., 150 in FIG. 8), the vehicle on-board display (e.g., 160 in FIG. 8), or a combination thereof.

In some embodiments, the memory 204 can include any suitable memory, storage, or a combination thereof for storing programs, data, and/or any other suitable information. For example, memory 204 can include volatile memory, non-volatile memory, or any combination thereof. In some embodiments, memory 204 can include random access memory, read-only memory, flash memory, a hard disk drive, a solid state drive, optical media, any other suitable memory, or any combination thereof.

In some embodiments, the device controller 206 can include any suitable processor or circuitry for controlling and receiving any input from the one or more input devices 208. In some embodiments, the one or more input devices 208 can include a touchscreen, a keyboard, a mouse, one or more buttons, a voice recognition circuit, a camera, one or more sensors, any other suitable input device, or any combination thereof. In some embodiments, the one or more sensors can include one or more accelerometers, one or more gyroscope sensors, one or more microphones, any other suitable sensors (e.g., an optical sensor, a temperature sensor, a near field sensor), or any combination thereof.

In some embodiments, the display and/or audio drivers 210 can include any suitable circuitry for controlling and driving output to one or more display and/or audio output devices 212. For example, the output devices can include a display (e.g., including a touchscreen, a flat-panel display, a cathode ray tube display, a projector, any other suitable display or presentation device, or any combination thereof), one or more speakers, or a combination thereof.

In some embodiments, the one or more communication interfaces 214 can include any suitable circuitry for interfacing with one or more communication networks. For example, the one or more communication interfaces 214 can include network interface card circuitry, wired communication circuitry, wireless communication circuitry, any other suitable communication network circuitry, or any combination thereof.

In some embodiments, the one or more antennas 216 can wirelessly communicate with a communication network. In some embodiments, the one or more antennas 216 can be omitted.

In some embodiments, the bus 218 can include any suitable communication system for communicating data, addresses, control signals, power, or any combination thereof, between two or more components 202, 204, 205, 206, 210, and 214. In some embodiments, the bus 218 can include any suitable conductors that are constructed and arranged to communicate data, addresses, control signals, power, or any combination thereof, between two or more components 202, 204, 205, 206, 210, and 214.

In some embodiments, any other suitable component(s) can be included in the computing device 100. In some embodiments, the computing device 100 can include an electronic control unit (e.g., 150 in FIG. 8) that is configured to monitor any sensors in a motor vehicle (e.g., 110 in FIG. 8).

According to variation 1, a liquid level sensing device can include a holding tank constructed to be mounted on a motor vehicle, wherein the holding tank is constructed to hold solid waste, liquid waste, water, or any combination thereof; an enclosure having a first side that includes at least one millimeter-wave lens, wherein the first side that includes the at least one millimeter-wave lens is mounted on the holding tank; at least one radar sensor mounted in the enclosure, wherein the at least one millimeter-wave lens is positioned between the holding tank and the at least one radar sensor; memory; one or more processors operably coupled to the memory and the at least one radar sensor, wherein the one or more processors are configured at least to: receive first radar sensor data from the at least one radar sensor; and determine a fill level of the holding tank based at least on the first radar sensor data.

According to variation 2, a liquid level sensing device can include a holding tank mounted on a motor vehicle; an enclosure having a first side that includes at least one millimeter-wave lens, wherein the first side that includes the at least one millimeter-wave lens is mounted on the holding tank; at least one radar sensor mounted in the enclosure, wherein the at least one millimeter-wave lens is positioned between the holding tank and the at least one radar sensor; memory; one or more processors operably coupled to the memory and the at least one radar sensor, wherein the one or more processors are configured at least to: receive first radar sensor data from the at least one radar sensor; and determine a fill level of the holding tank based at least on the first radar sensor data.

According to variation 3, a liquid level sensing device can include a holding tank constructed to be mounted on a motor vehicle; an enclosure having a first side that includes at least one millimeter-wave lens, wherein the first side that includes the at least one millimeter-wave lens is mounted on the holding tank; at least one radar sensor mounted in the enclosure, wherein the at least one millimeter-wave lens is positioned between the holding tank and the at least one radar sensor; one or more processors operably coupled to the at least one radar sensor, wherein the one or more processors are configured at least to: receive first radar sensor data from the at least one radar sensor; and determine a fill level of the holding tank based at least on the first radar sensor data.

Variation 4 can include the liquid level sensing device of variation 1, 2, or 3, wherein the holding tank does not include an opening that faces toward the at least one radar sensor.

Variation 5 can include the liquid level sensing device of variation 1, 2, or 3, wherein the holding tank does not include an opening that is aligned with the at least one radar sensor.

Variation 6 can include the liquid level sensing device of variation 1, 2, or 3, wherein at least one radar sensor is fluidly sealed from the holding tank.

Variation 7 can include the liquid level sensing device of variation 1, 2, or 3, wherein the first side of the enclosure that includes the at least one millimeter-wave lens is adhered to the holding tank.

Variation 8 can include the liquid level sensing device of variation 1, 2, or 3, further comprising: an enclosure mount adhered to the holding tank, wherein the enclosure mount is constructed and arranged to slidably receive the enclosure.

Variation 9 can include the liquid level sensing device of variation 1, 2, or 3, wherein the at least one millimeter-wave lens is made primarily of a dielectric material.

Variation 10 can include the liquid level sensing device of variation 1, 2, or 3, wherein the at least one radar sensor includes a pulsed coherent radar sensor.

Variation 11 can include the liquid level sensing device of variation 1, 2, or 3, wherein the at least one radar sensor is configured at least to: generate at least one radar beam pulse, wherein the at least one millimeter-wave lens is constructed and arranged to focus a portion of the at least one radar beam pulse toward the holding tank.

Variation 12 can include the liquid level sensing device of variation 1, 2, or 3, wherein the at least one radar sensor is configured at least to: generate radar beam pulses at a predetermined frequency.

Variation 13 can include the liquid level sensing device of variation 1, 2, or 3, wherein the one or more processors are further configured to: adjust a pulse frequency, a pulse duration, a pulse repetition interval, or any combination thereof, of radar beam pulses to be generated by the at least one radar sensor.

Variation 14 can include the liquid level sensing device of variation 1, 2, or 3, wherein the one or more processors are further configured to: generate at least one feature vector based at least on historical radar sensor data including the first radar sensor data; provide the at least one feature vector to a machine learning model that is configured to determine the fill level of the holding tank.

Variation 15 can include the liquid level sensing device of variation 1, 2, or 3, wherein the one or more processors are further configured to: perform digital signal processing on at least the first radar sensor data to remove noise, interference, or a combination thereof from at least the first radar sensor data.

Variation 16 can include the liquid level sensing device of variation 1, 2, or 3, wherein the one or more processors are operably coupled to at least one computing device mounted in the motor vehicle, wherein the at least one computing device is operably coupled to a vehicle on-board display.

Variation 17 can include the liquid level sensing device of variation 1, 2, or 3, further comprising the vehicle on-board display, wherein the vehicle on-board display is configured at least to display a fill level indicator indicating the fill level of the holding tank determined based at least on the first radar sensor data.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for anyone of the elements in the claims below or that a single element can be substituted for two or more elements in a claim. Although elements can be described above as acting in certain combinations, and even initially claimed as such, it is to be expressly understood that one or more elements from a claimed combination can, in some cases, be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible considering the above teachings without departing from the following claims.

What is claimed is:

1. A liquid level sensing device, comprising:
a holding tank constructed to be mounted on a motor vehicle, wherein the holding tank is constructed to hold solid waste, liquid waste, water, or any combination thereof;
an enclosure having a first side that includes at least one millimeter-wave lens, wherein the first side that includes the at least one millimeter-wave lens is mounted on the holding tank;
at least one radar sensor mounted in the enclosure, wherein the at least one millimeter-wave lens is positioned between the holding tank and the at least one radar sensor;
memory;
one or more processors operably coupled to the memory and the at least one radar sensor, wherein the one or more processors are configured at least to:
receive first radar sensor data from the at least one radar sensor; and
determine a fill level of the holding tank based at least on the first radar sensor data.

2. The liquid level sensing device of claim 1, wherein the holding tank does not include an opening that faces toward the at least one radar sensor.

3. The liquid level sensing device of claim 1, wherein the holding tank does not include an opening that is aligned with the at least one radar sensor.

4. The liquid level sensing device of claim 1, wherein at least one radar sensor is fluidly sealed from the holding tank.

5. The liquid level sensing device of claim 1, wherein the first side of the enclosure that includes the at least one millimeter-wave lens is adhered to the holding tank.

6. The liquid level sensing device of claim 1, further comprising:
an enclosure mount adhered to the holding tank, wherein the enclosure mount is constructed and arranged to slidably receive the enclosure.

7. The liquid level sensing device of claim 1, wherein the at least one millimeter-wave lens is made primarily of a dielectric material.

8. The liquid level sensing device of claim 1, wherein the at least one radar sensor includes a pulsed coherent radar sensor.

9. The liquid level sensing device of claim 1, wherein the at least one radar sensor is configured at least to:
generate at least one radar beam pulse, wherein the at least one millimeter-wave lens is constructed and arranged to focus a portion of the at least one radar beam pulse toward the holding tank.

10. The liquid level sensing device of claim 1, wherein the at least one radar sensor is configured at least to:
generate radar beam pulses at a predetermined frequency.

11. The liquid level sensing device of claim 1, wherein the one or more processors are further configured to:
adjust a pulse frequency, a pulse duration, a pulse repetition interval, or any combination thereof, of radar beam pulses to be generated by the at least one radar sensor.

12. The liquid level sensing device of claim 1, wherein the one or more processors are further configured to:
generate at least one feature vector based at least on historical radar sensor data including the first radar sensor data;
provide the at least one feature vector to a machine learning model that is configured to determine the fill level of the holding tank.

13. The liquid level sensing device of claim 1, wherein the one or more processors are further configured to:
perform digital signal processing on at least the first radar sensor data to remove noise, interference, or a combination thereof from at least the first radar sensor data.

14. The liquid level sensing device of claim 1, wherein the one or more processors are operably coupled to at least one computing device mounted in the motor vehicle, wherein the at least one computing device is operably coupled to a vehicle on-board display.

15. The liquid level sensing device of claim 14, further comprising the vehicle on-board display, wherein the vehicle on-board display is configured at least to display a fill level indicator indicating the fill level of the holding tank determined based at least on the first radar sensor data.

16. A liquid level sensing device, comprising:
a holding tank mounted on a motor vehicle;
an enclosure having a first side that includes at least one millimeter-wave lens, wherein the first side that includes the at least one millimeter-wave lens is mounted on the holding tank;
at least one radar sensor mounted in the enclosure, wherein the at least one millimeter-wave lens is positioned between the holding tank and the at least one radar sensor;
memory;
one or more processors operably coupled to the memory and the at least one radar sensor, wherein the one or more processors are configured at least to:
receive first radar sensor data from the at least one radar sensor; and
determine a fill level of the holding tank based at least on the first radar sensor data.

17. The liquid level sensing device of claim 16, further comprising:
an enclosure mount adhered to the holding tank, wherein the enclosure mount is constructed and arranged to slidably receive the enclosure.

18. The liquid level sensing device of claim 16, wherein the at least one millimeter-wave lens is made primarily of a dielectric material.

19. A liquid level sensing device, comprising:
a holding tank constructed to be mounted on a motor vehicle;
an enclosure having a first side that includes at least one millimeter-wave lens, wherein the first side that includes the at least one millimeter-wave lens is mounted on the holding tank;
at least one radar sensor mounted in the enclosure, wherein the at least one millimeter-wave lens is positioned between the holding tank and the at least one radar sensor;
one or more processors operably coupled to the at least one radar sensor, wherein the one or more processors are configured at least to:
receive first radar sensor data from the at least one radar sensor; and
determine a fill level of the holding tank based at least on the first radar sensor data.

20. The liquid level sensing device of claim 19, wherein the at least one millimeter-wave lens is made primarily of a dielectric material.
